(19) United States
(12) Patent Application Publication
(10) Pub. No.: US 2002/0171557 A1
(43) Pub. Date: Nov. 21, 2002

(54) Security electronic system

(76) Inventor: William E. Wegener, Fond du Lac, WI (US)

Correspondence Address: Donald Cayen, Suite 501, 104 South Main Street, Fond du Lac, WI, 54935, US

(21) Appl. No.: 09/860,730

(22) Filed: May 18, 2001

(51) Int. Cl. G08B 23/00

(52) U.S. Cl. 340/693.6; 340/693.5; 340/541

(57) ABSTRACT

A security electronic system comprises a monitoring/communication device mounted to a cap that removeably closes a housing. The housing is hung by a flexible obedient cable from a building ceiling or the like such that the monitoring device is proximate a target area. The flexible obedient cable is bendable to adjust the location of the monitoring device, but the flexible obedient cable indefinitely maintains the monitoring/communication device at the proper location. The monitoring/communication device may be a fixed or variable focus camera in monochrome or color, infrared illuminator/lighting, motion sensor, low voltage lighting, smoke detector, speaker audio unit, or other device that is back-mounted to the cap. Target areas remote from each other are serviced by separate distribution points, which minimizes the length of the necessary wires. At original installation, more wires than presently needed are run between distribution points to allow for economical future expansion of the security electronic system.

### BACKGROUND OF THE INVENTION

1. Field of the Invention

This invention pertains to security and communications systems, including monitoring and communications apparatus that is locatable close to selectable target areas. Such apparatus includes video cameras, motion sensors/detectors, smoke detectors, speaker units, and lighting.

2. Description of the Prior Art

Protection of persons and property is an important consideration in commercial and industrial buildings. Building owners and occupants recognize that the premises must be kept safe from physical hazards to employees and patrons. In some cases, unauthorized entry into or leaving a designated location must be prevented. A vital aspect of security at many businesses concerns mishandling of money and other valuable property, whether by employees or customers.

To minimize the various potential losses related to persons and property, it is well known for businesses to install surveillance and safety systems. The prior systems were often custom tailored to the specific type of business as well as to the physical construction of the site. The prior systems commonly used monitoring devices such as cameras, heat detectors, and motion sensors. Typically, signals from cameras were transmitted over coaxial cables to a central station for viewing images there. The images were usually recorded on a continuous basis. Appropriate action was taken in response to the signals.

Although prior surveillance/communication and safety systems have enjoyed some success, they nevertheless have substantial limitations in many instances. For example, in many buildings the distance between the cameras and the central station was very great. Signals transmitted through long distances by coaxial cables were susceptible to distortion. Accordingly, there was a risk that the signals as received at the central station were not reliable.

Prior safety and surveillance/communication systems used cameras or other monitoring devices that were invariably mounted in a fixed manner to a stationary object, such as a building ceiling or wall. In many installations, the camera or other monitoring device was close to the path of traffic of wheeled vehicles, such as forklift trucks. It was a common experience for a forklift truck to strike and damage the monitoring device. As a result, the system was out of order until the monitoring device was repaired. In addition to the loss of protection, the necessary repairs represented unproductive expenditures.

A further handicap of many prior safety and surveillance/communication systems was that the camera or other monitoring device was often located at a remote distance from the area that was to be protected. In buildings with high open ceilings, for example, a camera with a wide angle of view was often used. The camera was far above the target area. The camera could monitor a large target area, but with attendant loss of detail. In many instances, the images produced by the camera at the central station were too vague to, for example, identify a particular person.

To provide a wide angle of view as well as a high resolution image at the central station, it was a common practice to use combination power zoom pan and tilt cameras as monitoring devices. A person at the central station could control the camera to zoom onto a small portion of the target area and thereby see in great detail the activities occurring there. However, two problems arose with the use of power zoom cameras. First, a person had to be present at all times at the central station such that the zoom action could occur when needed. Having a person constantly monitoring the camera, even if the person could monitor more than one camera, was undesirably expensive. Second, zooming a camera necessarily reduced its angle of view. Consequently, while the camera was focused closely on one small portion of the target area, activities at other areas outside the reduced angle of view were unmonitored. The zoom, pan, and tilt features of the camera enabled it to select and closely focus on different portions of the target area when desired, but then other portions of the target area were left unmonitored. A related drawback to the power zoom pan and tilt cameras was that they were very expensive; a cost of approximately $1,500 was not unusual.

A related problem was that modern security related devices such as cameras, motion sensors, lighting, and smoke detectors are usually back-mounted to a support structure. Such a mounting is difficult to achieve in the high open ceilings of modern commercial and industrial buildings. Often an electrical box, board, or metal plate had to be installed first to the ceiling or wall in order to provide a suitable mounting surface. That procedure was inconvenient and time consuming.

Another problem associated with prior safety and surveillance/communication systems was that the cameras and other monitoring/communication devices were invariably mounted to the building ceiling or wall in a more or less permanent manner. Changing needs sometimes required relocating the monitoring device. For instance, a wall or sign may have been erected between the monitoring device and a target area. It was often a major job to make the necessary physical modifications to a prior system to regain an uninterrupted line of sight between the monitoring device and the target area.

Traditional video security systems normally included one coaxial cable and one pair of power wires that ran to each camera or other monitoring device from the central location. That design inherently limited the versatility of the system, causing additional expense and great inconvenience should expansion and/or relocation of electronic units be necessary or desired. The traditional design also inherently separated wiring for communication (both audio and video) from other electronics such as low-voltage infrared and standard lighting.

Thus, a need exists for improvements in safety and surveillance/communication systems.

### SUMMARY OF THE INVENTION

In accordance with the present invention, an inexpensive security electronic system is provided that is more versatile and useful than prior systems. This is accomplished by apparatus that includes a desired monitoring device suspended by a flexible obedient cable.

The monitoring device and flexible obedient cable are part of a monitoring assembly that can be installed at practically any location at a site. The monitoring assembly also includes an enclosure to which the monitoring device is mounted. According to one aspect of the invention, the enclosure is in two parts. The first part is a housing having a closed end and an open end. The housing open end is selectively closeable by a cap. The cap is preferably made from a relatively soft material that permits easy drilling and tapping into it. The cap is large and thick enough to enable a desired monitoring device to be back-mounted to it. A monitoring device of a low profile fixed-focus or manual vari-focal lens camera is ideal for mounting to the enclosure cap. Other surveillance and communications components ideal for the monitoring assembly include motion sensors/detectors, smoke detectors, glass break detectors, lighting (including low-voltage and infrared lighting fixtures) and speaker units.

The flexible obedient cable may be of any desired length. It has a unique combination of characteristics that enable it to be shaped by hand bending rather easily, but it remains indefinitely in the bent shape. The flexible obedient cable has an inner diameter that is sufficient to receive electrical and communication wires. The flexible obedient cable has a threaded fitting on at least one end.

The monitoring device is mounted to the enclosure cap. Electrical wires from the monitoring device pass through a hole in the cap.

One end of the flexible obedient cable is secured to the enclosure housing by the threaded fitting, which passes through a hole in the housing closed end and is secured by a lock-nut system. The lock-nut system allows the housing to be manually rotated 360 degrees to enhance adjustment capabilities. Electrical wires suitable for the particular monitoring device are fed through the flexible obedient cable until suitable lengths are present in the housing. The wire ends in the housing are connected to the wire from the monitoring device mounted on the cap. Then the cap is fastened on the housing open end to close the housing and protect the wires.

The security electronic system of the invention is used by hanging the flexible obedient cable at its second end from any convenient stationary member, such as a nearby wall or roof truss. In some systems, the flexible obedient cable second end may be held in an electrical junction box. Alternately, the flexible obedient cable second end may be strapped to the building member. The flexible obedient cable length from the place from which it is hung is chosen such that the monitoring device is at a selected location relative to the target area. Small adjustments to the location of the monitoring device are easily made by bending the flexible obedient cable the correct amount. The flexible obedient cable remains indefinitely in the shape to which it is bent, thereby assuring that the monitoring device does not drift from the selected location. In addition, the enclosure housing is able to rotate about the fitting on the flexible obedient cable, thereby adding to the ease of locating the monitoring device exactly as desired. The wires emerging from the flexible obedient cable second end are routed to a central station. There, signals from the monitoring device are processed in the manner suitable for that device. For example, if the monitoring device is a fixed-focus camera, the camera signals are representative of the view of the target area. The signals can be continuously recorded for playback and viewing at a later time, if desired. In that manner, it is not necessary that the central station always be staffed by a person for real time viewing. Similarly, the target area is always monitored, regardless of the presence of a person at the central station. In fact, if the monitoring device is a fixed-focus camera, a person at the central station is not able to change the view of the target area.

An important feature of the security electronic system of the invention is that it offers excellent versatility. The flexible obedient cable and the enclosure can be easily altered to suit changing conditions, as, for example, changing the target area. In some instances, changing the target area can be accomplished merely by moving the housing on the flexible obedient cable first end. In other installations, the flexible obedient cable merely has to be bent to a different configuration. If a complete relocation of the monitoring assembly is required, that is easily accomplished by releasing the flexible obedient cable second end and moving the monitoring assembly to the new location on the building ceiling or wall. This may be accomplished easily, as the flexible obedient cable may be mounted using simple cable ties commonly used in the electronic and construction industries. If changing conditions require that the enclosure and monitoring device be close to a traffic lane, the flexible obedient cable enables quick relocation of the enclosure and monitoring device if either is struck by passing traffic. In addition, the flexible obedient cable mounting system adds protection to the monitoring device, because the flexible obedient cable absorbs energy should the system be subject to an accidental or intentional blow.

Further in accordance with the present invention, signals from cameras are transmitted over long distances without distortion. For that purpose, coaxial cable is not used between the monitoring assembly and the central station. Instead, the signals are transmitted over a twisted wire pair, which inherently renders the signals immune to distortion. To enable the twisted wire pair to function, a first transceiver is located at the enclosure, and a second transceiver is located at or near the central station. The transceivers provide the necessary connections for the twisted wire pairs to the fittings on the camera and to the signal processing equipment at the central station.

In accordance with another aspect of the invention, multiple monitoring assemblies can be incorporated into a comprehensive security electronic system that covers all the desired target areas of a site. In many installations, the target areas are at considerable distances from each other and from the central station. The security electronic system enables all the target areas to be monitored in an economical and convenient way. That is achieved by incorporating a primary distribution point and a number of secondary distribution points into the security electronic system. The primary distribution point is normally placed close to the central station. The secondary distribution points are placed around the site as close as practical to several target areas that are remote from the central station. More than one target area can be serviced by each of the primary and secondary distribution points.

The primary or secondary distribution point supplies power (usually low voltage) for each of the monitoring assemblies served by that distribution point. The primary distribution point also has the second transceivers for each of the cameras serviced by the primary distribution point. Each second transceiver is connected by short lengths of coaxial cable to a multiplexer. Each second distribution point contains a power supply for each of the monitoring assemblies serviced by that distribution point.

At the time of installation, extra wiring can be run between the primary and secondary distribution points. Such wiring generally includes twisted-pair, voice, video, and data communication wire and general purpose stranded copper wire rated for low-voltage power and audio applications. In addition, the individual monitoring assemblies may be wired with more pairs of wire than initially needed, thus creating a third distribution point at each monitoring assembly for future enhancements or additions to the security electronic system. In that manner, additional monitoring assemblies can be installed and serviced by the secondary distribution point if later conditions warrant without having to rewire all the way from the primary to the secondary distribution points or to the monitoring assembly location.

In a further embodiment of the invention, multiple monitoring devices are installed in a monitoring assembly. In a particularly advantageous assembly, one or more ultra-miniature cameras are inserted through the wall of the monitoring assembly housing. The longitudinal axes of the lenses of the ultra-miniature cameras may be generally perpendicular to the longitudinal axis of the housing. By using four such cameras, a 360 degree view of a target area is available. A fixed lens dome camera, motion detector, or other monitoring device is mounted to the enclosure cap as described previously.

The method and apparatus of the invention, using an adjustably locatable monitoring device, thus continuously monitors a selected target area from a close and convenient location. The probability of missing an activity at the target area is remote, even though a person need not continuously monitor the security electronic system. The flexible obedient mounting system combined with the wiring methods described create a versatile and expandable security surveillance and communications system not previously available.

Other advantages, benefits, and features of the present invention will become apparent to those skilled in the art upon reading the detailed description of the invention.

### BRIEF DESCRIPTION OF THE DRAWINGS

FIG. 1 is a front view of a portion of a typical security electronic system according to the present invention.

FIG. 2 is a side view of FIG. 1.

FIG. 3 is a view generally similar to FIG. 1, but showing an alternate installation of the monitoring assembly.

FIG. 4 is a longitudinal cross-sectional view on an enlarged scale of the enclosure of the invention showing a typical fixed-focus or manually adjustable vari-focus camera mounted thereto.

FIG. 5 is a view taken along line 5-5 of FIG. 4.

FIG. 6 is a view taken along line 6-6 of FIG. 3.

FIG. 7 is a simplified schematic wiring diagram of the security electronic system.

FIG. 8 is a simplified schematic wiring diagram of a security electronic system containing several monitoring assemblies.

FIG. 9 is a simplified schematic wiring diagram of an installation of the invention containing monitoring assemblies serviced by primary and secondary distribution points.

FIG. 10 is a simplified wiring schematic drawing showing a security electronic system prepared for future expansion.

FIG. 11 is a simplified cross-sectional view of a multi-component monitoring assembly.

### DETAILED DESCRIPTION OF THE INVENTION

Although the disclosure hereof is detailed and exact to enable those skilled in the art to practice the invention, the physical embodiments herein disclosed merely exemplify the invention, which may be embodied in other specific structure. The scope of the invention is defined in the claims appended hereto.

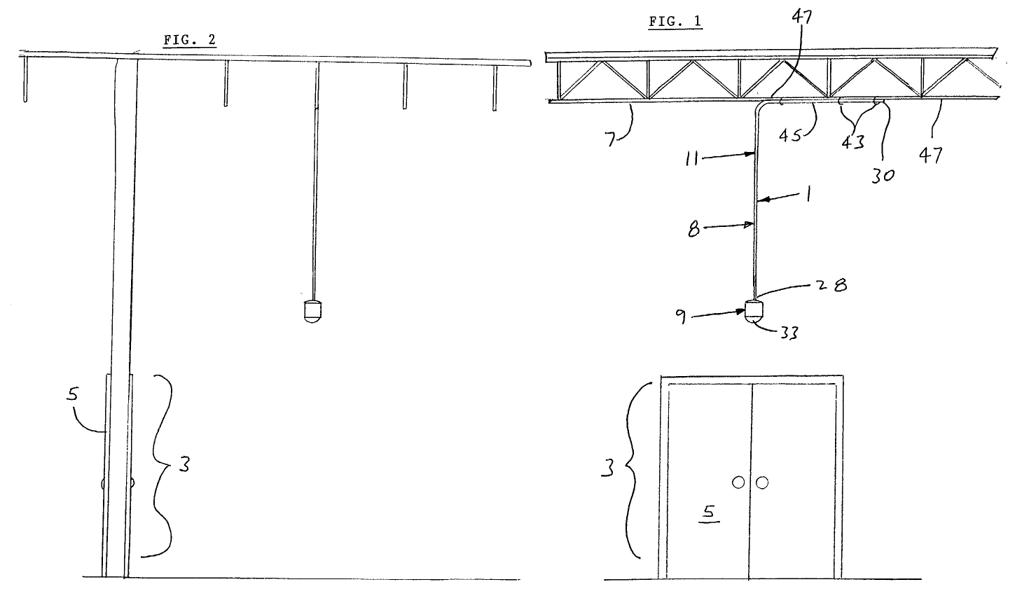

Referring to FIGS. 1 and 2, a portion of a security electronic system 1 is illustrated that includes the present invention. The security electronic system 1 is particularly useful for effective surveillance of a predetermined target area typically represented at reference numeral 3. As illustrated, the target area 3 is a building doorway 5, perhaps one through which only authorized personnel are allowed to pass. It will be appreciated, of course, that the target area 3 may be any of a wide variety of sites that are vulnerable to unwanted activities or events. In the illustrated example, the building with the target area 3 has a high open ceiling that includes a number of conventional roof trusses 7. Again, however, the invention is usable with numerous types of building constructions.

The security electronic system 1 is comprised of a monitoring assembly 8 including an enclosure 9 that is suspended from a building truss 7 by a flexible obedient cable 11. Looking also at FIGS. 4 and 5, the enclosure 9 comprises a hollow housing 13 and a cap 15. In the preferred embodiment, the housing 13 is round in shape, having an annular wall 16, a closed end 17, and an open end 19. The housing open end 19 is closeable by the cap 15. The cap has external threads 21 that mate with internal threads in the wall 16 at the housing open end 19. However, other means for closing the enclosure open end may be employed. For example, the cap may close the housing open end by means of screws that enter the housing wall 16.

The housing 13 and cap 15 may be made from any suitable material such as metal or plastic. I prefer a molded polyvinylchloride (PVC) material. Specifically, the housing may be a combination of a conventional PVC plumbing end cap that forms the closed end 17, bonded to the threaded end of a conventional plumbing drain cleanout. Housings with outer diameters of five inches and four inches work well. The cap may be a conventional plumbing cap that is normally used with the drain cleanout. To permit ease of turning the cap in and out of the housing, a slot 23 is formed in the cap outer surface 25. The cap also has an axial hole 26 through it.

The flexible obedient cable 11 has opposite ends 28 and 30 (FIGS. 1 and 2). I prefer a heavy duty type of flexible obedient cable as manufactured by Uniprise International, Inc. of Terryville, Conn. A flexible obedient cable having an inner diameter of approximately 0.50 inch is suitable. At each end 28 and 30 of the flexible obedient cable is a fitting, such as a short threaded nipple 27. A nipple 27 is inserted through a hole 29 in the housing closed end 17. The housing is secured to the flexible obedient cable by a lock-nut and rubber washer 31.

The security electronic system 1 further comprises a monitoring device 33. The particular kind of monitoring device 33 is a function of the target area 3 that is to be monitored. An example of a monitoring device that works very well in numerous applications is a model DM-935CV color dome damera manufactured by GBC/Sentrol/Interlogix of Hackensack, N.J. That color integrated dome camera has a variable focus manually adjustable lens from approximately 3.0 millimeters to 6.0 millimeters to change the focus and angle of view. Another satisfactory monitoring device is a model WDD-7500C color dome camera manufactured by Weldex of Korea. That camera has a fixed-focus that provides a clear image with a variety of lenses for a particular application. The GBC DM-935CV color dome camera fits larger sizes of housings 13, while the Weldex WDD-7500C with fixed lenses fits smaller size housings. The monitoring device is back-mounted to the cap outside surface 25 by conventional fasteners typically shown at reference numeral 35. The PVC material of the cap 15 makes it an easy task to drill and tap the cap for the fasteners 35.

A video wire and connector 37, and a power wire and connector 38, from the monitoring device 33 pass through the cap hole 26. The video connector 37 is connected to a first balun transceiver 40. A suitable transceiver 40 is a model UB37 Video Balun manufactured by Northern Information Technology, Inc. of Arlington Heights, Ill. From the first transceiver, a twisted wire pair 39 is fed through the flexible obedient cable 11 to emerge from the end 30. Power wires 42, with a power connector 44 on one end, are also fed through the flexible obedient cable. When the cap 15 with the monitoring device 33 mounted to it is removed from the housing 13, the power connectors 38 and 44 are connected to each other, and the transceiver 40 is connected to the twisted wire pair 39. When the cap is threaded back into the housing, the wires, connectors, and transceiver are hidden from view and protected from damage.

The enclosure 9 with the monitoring device 33 is suspended at the desired location relative to the target area 3 by the flexible obedient cable 11. As illustrated in FIGS. 1 and 2, the flexible obedient cable is hung from a suitable truss 7 of the building. A satisfactory way to hang the flexible obedient cable is by well known cable ties 43 wrapped around a horizontal length 45 of the flexible obedient cable that is laid alongside a truss rod 47. The wires 39 and 42 emerging from the flexible obedient cable are connected to other parts of the security electronic system 1, as will be described in detail shortly. With the installation arrangement of FIGS. 1 and 2, the nipple 27 at the flexible obedient cable end 30 is not used.

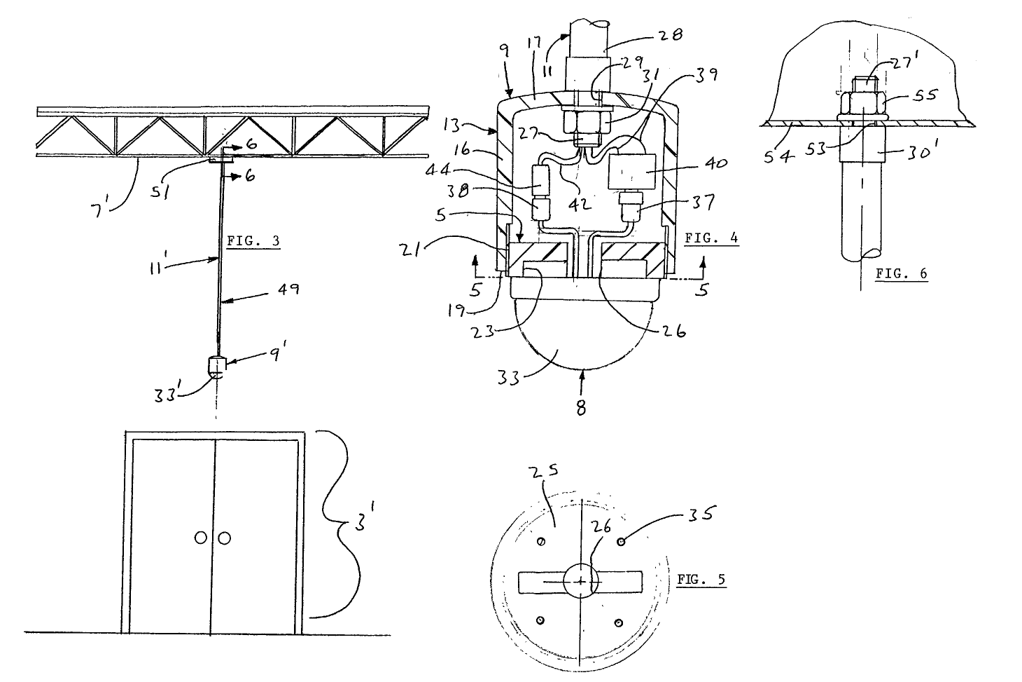

Turning to FIGS. 3 and 6, an alternate way of installing a security electronic system 49 is illustrated. The security electronic system 49 is intended to monitor a selected target area 3′. The security electronic system 49 comprises an enclosure 9′ having a monitoring device 33′ back-mounted to it. The enclosure 9′ is suspended by a flexible obedient cable 11′ from a conventional electrical box 51. The electrical box 51 is shown as being affixed to a truss 7′ of a building ceiling. However, the electrical box may be affixed to any convenient place near the target area 3′.

The flexible obedient cable 11′ is held by its end 30′ to the electrical box cover 54. Specifically, the nipple 27′ at the end 30′ is inserted through a hole 53 in the cover 54. A nut and washer 55 threaded onto the nipple 27′ firmly holds the flexible obedient cable to the electrical box 51.

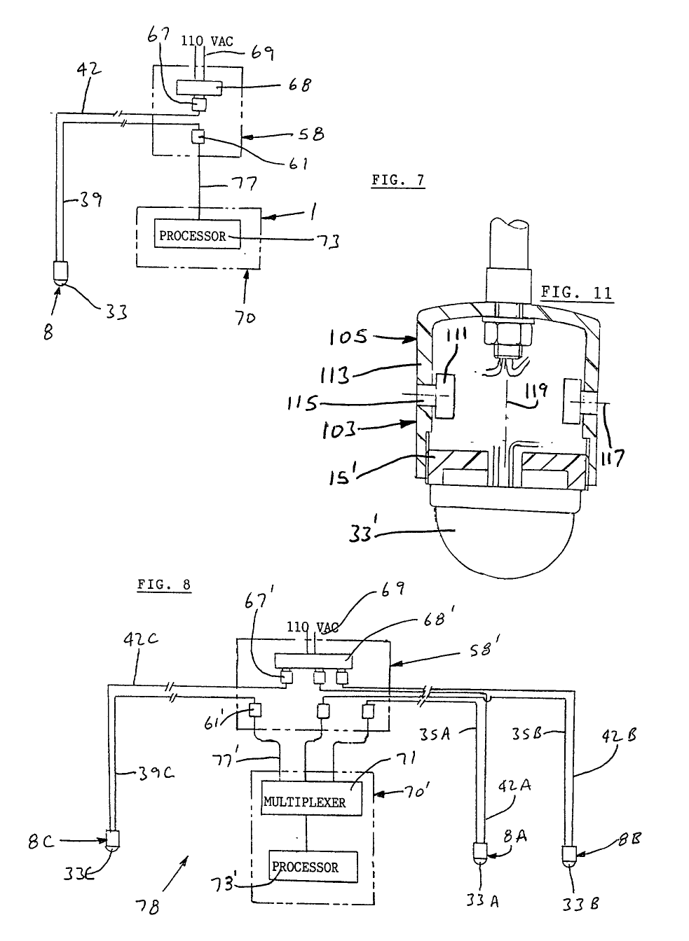

FIG. 7 shows a wiring schematic diagram for the security electronic system 1. The power wire 42 and video wire 39 of the monitoring assembly 8 (FIG. 4) lead to a distribution point 58. At the distribution point 58 is a source 69 of 110 volt AC power. A conventional AC/DC transformer 67 is plugged into the source 69 of AC power, as by a power strip 68. The monitoring device power wire 42 connects to the transformer 67. The video wire connects to a second transceiver 61 at the distribution point.

Although the monitoring assembly 8 can be located anywhere on the premises, the primary distribution point 58 is usually located close to a central station 70. At the central station 70 is a switcher or multiplexer and monitor-recorder 73. A video wire 77, which may be a short coaxial cable, runs from the transceiver 61 to the switcher or multiplexer and monitor-recorder 73. By appropriately controlling the monitor-recorder, signals from the monitoring device 33 may be viewed in real time and/or recorded for later playback.

An outstanding advantage of the security electronic system 1 is that the monitoring device 33 is not limited to a fixed-focus camera. The present invention is eminently suitable for handling other security devices such as low voltage lights. An example is a back-mounted angled overhead light accessory marketed by Heath Zenith Company of Canada. Another suitable monitoring device is a back-mounted Model 400 or Model 700 smoke detector marketed by Sentrol/Interlogix of Hackensack, N.J. Other suitable monitoring devices are back-mounted infrared illuminators marketed under the Silent Witness trademark, and back-mounted motion sensors such as Model AP669 marketed under the trademark Sentrol/Interlogix. The exact wiring arrangement between the monitoring device and the central station will vary with each of the foregoing devices. With each device, however, the cap 15 is easily drilled and tapped for the particular mounting pattern. Further, the removed cap enables easy connections between the monitoring device and the wires that lead to the control station 70. It will be understood, of course, that the particular equipment at the central station will vary depending on the monitoring device used.

Another important benefit of the security electronic system 1 is that it can service multiple monitoring and communication assemblies from a single distribution point. In most security electronic systems, there are several target areas. FIG. 8 shows a security electronic system 78 having three monitoring assemblies 8A, 8B, and 8C. Each of the monitoring assemblies 8A-8C is located so as to monitor a respective selected target area, not shown. The monitoring assemblies 8A-8C utilize the same enclosure and flexible obedient cable as the monitoring assembly 8, as explained previously in connection with FIGS. 1, 2, 4, and 5. The monitoring devices 33A, 33B, and 33C of the monitoring assemblies 8A-8C, respectively, may be any of those described above. The corresponding signals are transmitted over wires 39A-39C to a distribution point 58′. At the distribution point 58′ is a transceiver 61′ for each signal wire 39A-39C. There is also an AC/DC transformer 67′ at the distribution point 58′ for each power wire 42A-42C. The wires 42A-42C supply DC power from the AC source 69′ to the respective monitoring devices 33A-33C. Signal wires 77′, which may be coaxial cables, lead to a central station 70′. The central station 70′ includes a multiplexer 71 in addition to a monitor-recorder 73′. The multiplexer 71 and monitor-recorder 73′ can be controlled to remotely view the target areas monitored by the monitor devices 33A-33C in real time as well as to record the signals from the monitoring devices for later viewing.

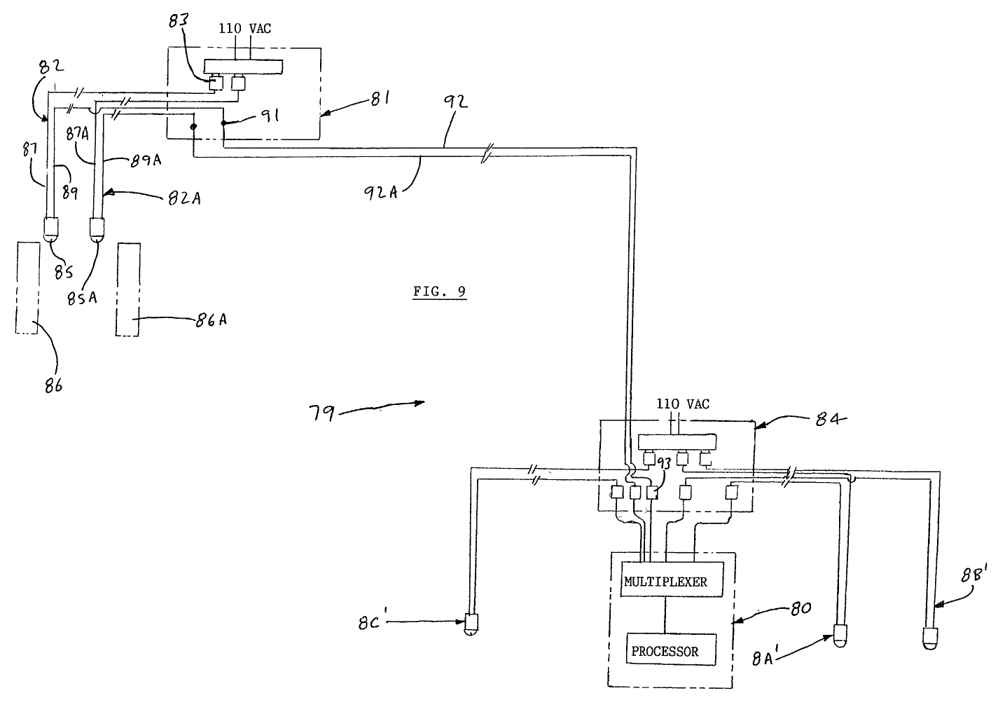

Further in accordance with the present invention, target areas at widely scattered locations at a site can be monitored with ease and economy. Turning to FIG. 9, a typical security electronic system 79 has a central station 80, and a primary distribution point 84 relatively close by. The primary distribution point 84 services three monitoring assemblies 8A′, 8B′, and 8C′. In the security electronic system 79, two target areas schematically represented at reference numerals 86 and 86A are to be monitored. The target areas 86 and 86A are located at a great distance, such as 1,000 feet, from the primary distribution point 84. To maximize the economy and convenience of the security electronic system 79, a secondary distribution point 81 is placed as close as practical to the target areas 86 and 86A. Monitoring assemblies 82 and 82A, substantially similar to the monitoring assembly 8 described previously, are installed from a convenient stationary member. Monitoring devices 85 and 85A, which are part of the monitoring assemblies 82 and 82A, respectively, are located to monitor the target areas 86 and 86A.

The secondary distribution point 81 contains AC/DC transformers 83 that supply power to the monitoring devices 85 and 85A over respective power wires 87 and 87A. Signals from the monitoring devices 85 and 85A are transmitted over twisted wire pairs 89 and 89A to respective junctions 91 in the secondary distribution point. The junctions 91 connect the twisted wire pairs 89 and 89A to long twisted wire pairs 92 and 92A, respectively, that run back to associated transceivers 93 in the primary distribution point 84. In that manner, target areas such as 86 and 86A at remote distances from the primary distribution point and the central station 80 can be monitored without signal distortion, because only runs of twisted wire pairs are used between the primary and secondary distribution points.

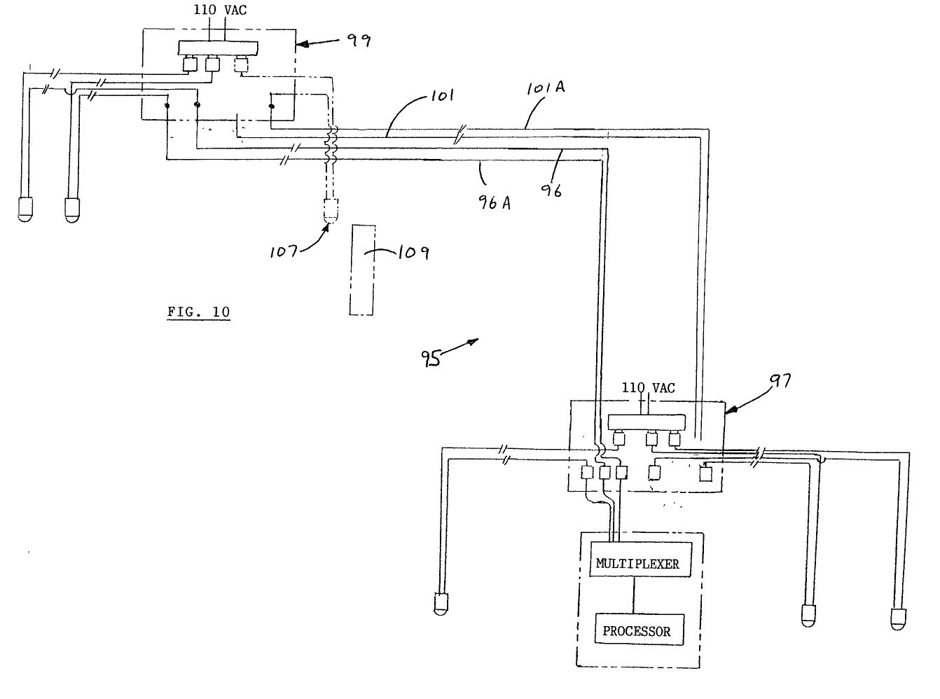

The versatility of the present invention is further demonstrated with regard to FIG. 10. In FIG. 10, a security electronic system 95 with primary and secondary distribution points 97 and 99, respectively, is shown that is designed to monitor target areas similar to the target areas monitored by the security electronic system 79 of FIG. 9. The security electronic system 95 includes twisted wire pairs of signal wires 96 and 96A between the primary distribution point 97 and the secondary distribution point 99. However, the security electronic system 95 is initially installed to provide for future expansion. In the installation process, a major expense is the labor of running the signal wires 96 and 96A between the primary and secondary distribution points 97 and 99, respectively. That is because the wires 96 and 96A are usually run along the ceiling of a building. Working along the ceiling is time consuming and requires the use of power lifts or other specialized equipment. In addition, the wire installation process disrupts activities on the building floor. Accordingly, if future requirements call for more target areas to be monitored, it would be very expensive to rerun additional signal wires, represented at reference numerals 101 and 101A, between the distribution points. As an important aspect of the invention, however, the signal wires 101 and 101A are installed along with the wires 96 and 96A at the time of initial installation, even though the wires 101 and 101A are not needed at the time. The initially greater cost of the unused twisted wire pairs 101 and 101A is more than recovered when one or more additional monitoring assemblies, shown in phantom at reference numeral 107, is added to monitor a new target area 109.

FIG. 11 illustrates a further embodiment of the invention. A monitoring assembly 103 has a housing 105 with a cap 15′. A monitoring device 33′, such as a color dome camera, motion detector, or smoke detector, is back-mounted to the cap 15′ as described previously. The monitoring assembly 103 further includes one or more ultra-miniature cameras 111 inserted through the wall 113 of the housing 105. A suitable ultra-miniature camera is approximately 1.38 inches square and 0.38 inches deep, and has a lens 115 of approximately 0.56 inches diameter. In the embodiment of FIG. 11, the camera lens 115 is inserted through the housing wall 113 with the lens longitudinal axis 115 generally perpendicular to the housing longitudinal axis 119. The camera lens may be retained in place by an adhesive between the lens and the housing wall. By using four wide angle fixed focus ultra-miniature cameras, 360 degrees of view is available. For clarity, the tranceivers associated with the ultra-miniature cameras are not shown in FIG. 11.

In summary, the results and advantages of cameras, motion sensors, low voltage lighting, smoke alarms, and similar devices that monitor activities at a desired target area can now be more fully realized. The security electronic system provides both close-up monitoring of and communication to and from (two-way) a target area as well as great versatility in adapting to physical environments. This desirable result comes from using the combined functions of the monitoring assemblies and the distribution points. The monitoring assembly cap 15 enables any of several monitoring devices to be back-mounted to the enclosure 9 with ease. The cap closes the housing 13 in a manner that both enables connection of power and signal wires and protects the connections. The flexible obedient cable is bendable to enable easy adjustment of the location of the monitoring device, and the flexible obedient cable remains permanently in the desired bent configuration. The flexible obedient cable can be hung from any convenient structural member, such as a truss of an open ceiling or a wall. Because of the close proximity of the monitoring device to the target area, activities at the target area can be monitored with clarity, and cameras can utilize a wide angle of view. Depending on the particular monitoring device used, real time monitoring is usually not required. The distribution points enable widely separated target areas to be monitored with convenience and low cost. Also, because twisted wire pairs are used for the long runs between the monitoring devices and the central station, minimal if any signal distortion occurs. Providing more signal and power wire capacity than is required at initial installation further adds to the economy and versatility of the invention. As a related benefit, the present invention utilizes expandable, structured wiring such as two-pair power line and four-pair twisted pair directly from each monitoring assembly. That construction allows for versatility and expansion at each monitoring assembly in the system. The wiring of the invention also permits additions and changes in the security electronic system components without costly and inconvenient rewiring. Also, the twisted-pair style wiring is dramatically smaller in diameter and weight than traditional coaxial cable. That makes the wiring less expense to ship, easier to handle and install, and more physically flexible. Such flexibility and tolerance to stress are ideal for the enclosure in conjunction with the components utilizing the flexible obedient cables.

It will also be recognized that in addition to the superior performance of the invention, its life cycle cost is less than that of traditional safety and surveillance systems. Moreover, since the mechanical components are simple and rugged, the need for maintenance is virtually eliminated.

Thus, it is apparent that there has been provided, in accordance with the invention, a security electronic system that satisfies the aims and advantages set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

I claim:

1. A security electronic system comprising:
a. a first monitoring assembly comprising:
i. an enclosure;
ii. a first monitoring device mounted to the enclosure and including at least one electrical wire, the first monitoring device producing signals in said at least one electrical wire in response to activities occurring at a target area; and
iii. a flexible obedient cable having a first end secured to the enclosure, and a second end hung from a selected stationary member, the flexible obedient cable being bendable to enable adjustment of the enclosure to a location whereat the first monitoring device monitors the target area; and
b. means for processing the signals produced in said at least one electrical wire by the first monitoring device.

2. The security electronic system of claim 1 wherein the enclosure comprises:
a. a housing having first and second ends, a wall, and a longitudinal axis; and
b. a cap removeably fit in the housing first end, the first monitoring device being mounted to the cap,
so that said at least one electrical wire is connectable to the means for processing the signals produced by the first monitoring device when the cap is removed from the housing, and said at least one electrical wire is protected inside the housing when the cap is fit in the housing first end.

3. The security electronic system of claim 2 wherein:
a. the flexible obedient cable has a fitting at the first end thereof that is inserted through a hole in the housing second end; and
b. a nut cooperates with the flexible obedient cable fitting to secure the flexible obedient cable first end to the housing.

4. The security electronic system of claim 1 further comprising at least one cable tie used to hang the flexible obedient cable second end from the selected stationary member.

5. The security electronic system of claim 2 wherein:
a. the security electronic further comprises an electrical box affixed to a selected stationary member and having a cover having a hole therethrough;
b. the flexible obedient cable first and second ends have respective first and second fittings thereon;
c. the flexible obedient cable first fitting is inserted through a hole in the housing second end;
d. the flexible obedient cable second fitting is inserted through the hole in the electrical box cover; and
e. first and second nuts cooperate with the flexible obedient cable first and second fittings, respectively, to secure the flexible obedient cable first and second ends to the enclosure and the electrical box.

6. The security electronic system of claim 1 wherein the first monitoring device is chosen from the group consisting of a fixed-focused camera, variable focus camera, smoke detector, motion sensor, infrared illuminator, low voltage light, and audio speaker.

7. The security electronic system of claim 1 wherein the means for processing the signals comprises:
a. a central station;
b. a first distribution point;
c. a first transceiver in the enclosure connected to said at least one monitoring device electrical wire;
d. a second transceiver at the first distribution point;
e. a first twisted wire pair between the first and second transceivers; and
f. means for conducting signals from the second transceiver to the central station.

8. The security electronic system of claim 7 wherein:
a. the security electronic system comprises multiple first monitoring assemblies; and
b. the means for processing the signals comprises:
i. a second transceiver at the first distribution point corresponding to each first monitoring assembly;
ii. twisted wire pairs between the first transceivers at the respective first monitoring assemblies and the associated second transceivers at the first distribution point; and
iii. means for conducting signals from the second transceivers to the central station.

9. The security electronic system of claim 7 further comprising:
a. at least one second monitoring assembly;
b. a third transceiver in operative association with said at least one second monitoring assembly;
c. a second distribution point;
d. a fourth transceiver in the first distribution point;
e. a second twisted wire pair between said at least one second monitoring assembly and the second distribution point;
f. a third twisted wire pair joined to the second twisted wire pair at the second distribution point and running to the fourth transceiver; and
g. means for conducting signals from the fourth transceiver to the central station.

10. The security electronic system of claim 9 further comprising at least one twisted wire pair between the first and second distribution points greater than the number of second monitoring assemblies.

11. The security electronic system of claim 2 further comprising at least one second monitoring device inserted through the wall of the housing.

12. The security electronic system of claim 11 wherein said at least one second monitoring device is an ultra-miniature camera having a lense, and wherein the lense of the ultra-miniature camera is inserted through the housing wall.

13. Apparatus for monitoring a selected target area comprising:
a. a flexible obedient cable having a first end held to a selected stationary member, and a second end located proximate the selected target area;
b. an enclosure secured to the flexible obedient cable second end; and
c. a first monitoring device mounted to the enclosure, the flexible obedient cable being bendable to adjust the first monitoring device to monitor the selected target area, and the flexible obedient cable subsequently remaining in place to maintain the monitoring device in monitoring relation to the selected target area.

14. The apparatus of claim 13 further comprising cable ties that hold the flexible obedient cable first end to the selected stationary member.

15. The apparatus of claim 13 wherein:
a. the enclosure comprises:
i. a housing having a wall and an open end; and
ii. a cap that removeably closes the housing second end; and
b. the first monitoring device is mounted to the cap.

16. The apparatus of claim 15 wherein:
a. the flexible obedient cable second end has a fitting therein that passes through a hole in the housing; and
b. a nut cooperates with the flexible obedient cable fitting to secure the housing to the flexible obedient cable.

17. The apparatus of claim 15 wherein the housing and the cap are made of a polyvinylchloride plastic material.

18. The apparatus of claim 15 wherein:
a. the housing has an annular wall with threads therein; and
b. the cap has threads that mate with the housing threads to thereby removeably close the housing open end.

19. The apparatus of claim 15 wherein the first monitoring device is back-mounted to the cap.

20. The apparatus of claim 15 wherein the first monitoring device is chosen from the group consisting of a fixed-focused camera, vari-focal camera, smoke detector, motion sensor, infrared illuminator, low voltage light, and speaker/audio unit.

21. The apparatus of claim 15 further comprising said at least one second monitoring device inserted in the housing wall.

22. A method of monitoring a selected target area comprising the steps of:
a. mounting at least one monitoring device to an enclosure;
b. securing the enclosure to one end of an elongated flexible obedient cable;
c. hanging a second end of the flexible obedient cable from a stationary member such that said at least one monitoring device and enclosure are proximate a selected target area; and
d. bending the flexible obedient cable such that said at least one monitoring device monitors the selected target area.

23. The method of claim 22 wherein the step of mounting at least one monitoring device comprises the steps of:
a. providing a housing having a wall with an open end, and providing a cap;
b. mounting a first monitoring device to the cap; and
c. closing the housing open end with the cap.

24. The method of claim 23 wherein the step of securing the enclosure to one end of the flexible obedient cable comprises the step of securing the housing to said one end of the flexible obedient cable.

25. The method of claim 23 wherein the step of mounting a first monitoring device to the cap comprises the steps of drilling and tapping the cap, and back-mounting the first monitoring device to the cap.

26. The method of claim 23 comprising the further steps of providing at least one second monitoring device inside the housing, and inserting said at least one second monitoring device through the housing wall.

27. A method of installing a security electronic system comprising the steps of:
a. mounting at least one monitoring device to an enclosure;
b. securing the enclosure to a first end of an elongated flexible obedient cable;
c. hanging the flexible obedient cable by a second end thereof from a selected stationary member such that the enclosure is proximate a selected target area; and
d. bending the flexible obedient cable such that the monitoring device monitors the selected target area.

28. The method of claim 27 wherein the step of mounting at least one monitoring device comprises the steps of providing a housing and a cap, and mounting a first monitoring device to the cap.

29. The method of claim 28 wherein the step of securing the enclosure comprises the step of securing the housing to the flexible obedient cable.

30. The method of claim 27 comprising the further steps of:
a. running at least one wire from the monitoring device through the enclosure and the flexible obedient cable and out the second end thereof and to a first distribution point; and
b. connecting said at least one wire at the first distribution point to a central location.

31. The method of claim 30 wherein the step of running at least one wire comprises the steps of:
a. providing a first transceiver in the enclosure;
b. providing a second transceiver in the first distribution point;
c. running a twisted wire pair between the first and second transceivers; and
d. electrically connecting the second transceiver to the central station.

32. The method of claim 28 comprising the further step of mounting at least one second monitoring device to the enclosure housing.

33. A method of providing electronic security to first and second target areas comprising the steps of:
a. providing first and second monitoring assemblies each comprising an enclosure, at least one monitoring device mounted to the enclosure, and a flexible obedient cable secured to the enclosure;
b. hanging the first monitoring assembly by means of the associated flexible obedient cable from a first stationary member such that the monitoring device thereof is proximate a first target area;
c. hanging the second monitoring assembly by means of the associated flexible obedient cable from a second stationary member such that said at least one monitoring device thereof is proximate a second target area;
d. providing first and second distribution points;
e. running at least one first electrical wire from the first monitoring assembly to the first distribution point;
f. running at least one second electrical wire from the second monitoring assembly to the second distribution point, and running at least one third electrical wire from the second distribution point to the first distribution point;
g. electrically connecting said at least one first and second electrical wires at the first distribution point to a central station; and
h. producing signals in the monitoring devices in response to activities at the first and second target areas.

34. The method of claim 33 comprising the further steps of running unused wires between the first and second distribution points and thereby providing for installation of additional monitoring assemblies proximate the second distribution point without having to run wires between the first and second distribution points when the additional monitoring assemblies are installed.
